(19) United States
(12) Patent Application Publication
(10) Pub. No.: US 2007/0103639 A1
(43) Pub. Date: May 10, 2007

(54) Method of manufacturing a mould for producing an optical surface, a method of producing a contact lens and a device for use with these methods

(75) Inventors: Antonius Johannes Maria Nellissen, Eindhoven (NL); Hendrikus Gerardus Petrus Cornelis Van Doormalen, Eindhoven (NL); Theodorus Josephus Maria Van Der Putten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/563,932

(22) PCT Filed: Jul. 6, 2004
(86) PCT No.: PCT/IB04/51146

§ 371 Date: Jan. 9, 2006

(30) Foreign Application Priority Data
Jul. 11, 2003 (EP) 03102107.4

(51) Int. Cl. G02C 7/04; B29D 11/00; B29C 35/08

(52) U.S. Cl. 351/160 R; 264/2.5; 264/1.32; 264/1.38; 425/174.4

(57) ABSTRACT

A method of manufacturing a mould for producing a customized optical surface, whereby a mould (1, 2) having a base shape is modified in order to obtain the required shape of the mould. The modificaiton is carried out by means of a lithographic process comprising coating the mould surface with a photoresist layer (16), exposing the layer to a predetermined pattern of exposure radiation (9) and developing the exposed layer whereby portions of the layer are removed to obtain the required mould shape (22). This method may be used for producing small quantities of optical surfaces, such as for individual contact lenses.

The invention relates to a method of manufacturing a mould for producing a customized optical surface, whereby a mould having a base shape is modified to obtain the required shape of the mould surface. The invention also relates to a method of producing a customized contact lens using a composed such mould and to a device for use with these methods.

An optical surface is understood to mean a surface of an optical element, such as a lens, which surface changes the wave front of a beam of radiation passing the surface. A customized optical surface is understood to mean a surface that is especially designed for a specific purpose or for a specific user, such as a spectacle or contact lens wearer.

A conventional method of manufacturing a contact lens uses a composed mould and curing a UV hardening polymer between a first mould part having a concave mould surface and a second mould part having a convex mould surface. Such a mould is often made of a plastic material. The plastic mould can be made by injection moulding with a metal mould.

A contact lens has a concave surface, which should abut the human eye and therefore is called the base surface, and a convex surface, which is called the front surface. Such a contact lens should correct the human eye for a/o spherical and cylindrical aberrations. The degree of correction varies from eye to eye. Therefore, the conventional manufacturing method requires a large number of predefined mould shapes to choose from in order to obtain the desired eye correction. Furthermore, besides correction of spherical and cylindrical aberrations it is desired to correct also for higher order aberrations, whereby in fact a customized lens has to be manufactured, i.e. a lens which is appropriate for only one person. The manufacturing of a customized lens requires a special customized mould and that mould can only be used for manufacturing a number of lenses for that one person.

A mould for manufacturing a customized contact lens, i.e. a customized mould, can be obtained by modifying a mould having a base shape. A base shape is understood to mean a shape that approximates the required, customized, shape to a certain degree such that only limited modifications are needed to obtain the required shape. The mould having the base shape can be chosen from a limited number of standard moulds which are produced on the conventional way, for example by injection moulding with a metal mould. The modification of a composed mould comprises the modification of the shape of one or of both surfaces, the concave surface and the convex surface respectively, each abutting a different surface of the contact lens during the moulding process of the contact lens.

The said surface modification can be performed by mechanically removing mould material. However, this is a time consuming method. Moreover the machined area of the mould surface must undergo a finishing operation to obtain the required smooth surface of the mould. Another method of surface modification, which is disclosed in WO02/0559169, is based on sagging, under controlled conditions, of the mould surface resting on an array of individually controllable actuators deform the surface of the mould into the desired shape during the moulding operation. This method requires a complicated device, especially in case detailed modifications are required.

It is an object of the present invention to provide a relative simple and cheap method of manufacturing a mould for producing a customized optical surface.

This method is characterized in that use is made of a photolithographic process, comprising the steps of
providing the mould surface with photoresist layer;
exposing the photoresist layer to a predetermined pattern of exposure radiation during a predetermined time, and
developing the photoresist layer, thereby selectively removing photoresist material according to the radiation pattern and shaping the exposed surface of the layer to the required end shape of the mould, This method can be used for manufacturing moulds not only for contact lenses, but also for spectacle glasses and moulds for corrective optical elements to be used in optical apparatuses.

Photolithography is a process that is known per se for manufacturing integrated circuits (ICs) liquid crystal displays (LCD's) etc, whereby a two-dimensional mask pattern is transferred to a two-dimensional image in a resist layer on s substrate, or wafer. The present invention uses the lithographic process to transfer a two-dimensional mask pattern into a three-dimensional shape of a surface. Thereby the surface is coated with a layer of photoresist, for example a polymer material that is sensitive to UV radiation, or another material that is sensitive to radiation of another wavelength, if preferred. After exposure of the resist layer to a patterned beam of UV radiation, i.e. radiation that has passed the mask pattern, the resist material is developed by means of a developer solution. Thereby portions of the resist material are removed according to the patterned exposure and the remaining resist layer material forms the required surface shape.

There are two types of photoresist: positive and negative. For positive photoresists, the exposed portions will be removed upon developing. Exposing a positive photoresist causes a change of its chemical structure such the resist becomes more soluble in the developer solution. The exposed resist portions are then removed by the developer solution, so that “holes” in the resist material are left. A negative photoresist behaves in the opposite manner. Exposure of a negative resist causes its to polymerize and thus more difficult to dissolve. Therefore, exposed portions of a negative resist material remain on the surface and only unexposed portions of the material are removed during the developing operation.

Preferably the so called “hot flow” development method is used, because developing with a liquid provides less smoothness. Hot flow development means that the mould part with exposed photoresist is heated to a predetermined temperature. This makes the unexposed resist fluid. By fast spinning the mould part the excess of unpolymerized resist is removed.

A preferred embodiment of the method is characterized in that use is made of as negative-photoresist layer.

Another embodiment is characterized in that the mould is made of a material that is transparent to the exposure radiation.

A further embodiment of the method is characterized in that the mould is made of a plastic material.

The embodiment wherein a negative-photoresist layer is used is preferably characterized in that the photoresist layer is exposed via the mould.

The invention further relates to a method of manufacturing of a composed mould for producing a contact lens, which composed mould comprises a first and a second mould for forming a first surface and a second surface, respectively of the contact lens. This method is characterized in that each of the moulds is manufactured by the method as described herein before.

As a mould for a customized contact lens has a very limited use, the advantages of the method, i.e. an simple and cheap process, are used to the optimum when manufacturing such a mould.

The invention also relates to a method of manufacturing a contact lens comprising a first, concave, surface and a second, convex, surface, which method comprises the steps of:
providing a composed mould comprising a first mould having a surface, which is the negative of the first lens surface, and a second mould having a surface, which is the negative of the second lens surface;
filling the space between the mould surface with a polymer material;
exposing the polymer material to UV radiation thereby hardening the material and shaping it to a lens having the said first and second surface. This method is characterized in that use is made of a composed mould manufactured according to the above described method of manufacturing a composed mould.

Using the simply and cheaply manufactured composed mould in the method of producing the contact lens makes the latter method also simply and cheaply so that the invention is also embedded in this method. The same holds for the produced contact lens.

Finally, the invention also relates to a device for performing the exposure step of the method of manufacturing a mould as described herein above. This device is characterized in that it comprises in this order:
a radiation source emitting UV radiation;
optical means for concentrating the emitted radiation in an exposure beam;
a spatial light modulator for imparting to the exposure beam a radiation distribution according to the said predetermined pattern, and
a mould holder arranged in the path of the radiation from the spatial light modulator for holding the mould to be exposed.
   The spatial light modulator (SLM) is an important component of the device. In a conventional lithographic projection apparatus a rigid photo mask, which is of digital nature, i.e. black/white, is used. In contrast therewith, a spatial light modulator can generate easily changeable images, which, moreover, may contain a large number of different gray tones. By means of an SLM images with gradually varying intensity can be generated, which is required to obtain the required surface relief pattern for a customized mould.

An embodiment of this device is characterized in that the spatial light modulator is one of the types: liquid crystal display (LCD), digital mirror device (MD) and deformable mirror device.

Liquid crystal displays are well-known per se and are currently used in image projection apparatus to generate an image that is to be displayed on an enlarged scale. The LCD may be a transmission LCD or a reflective LCD. The latter shows the advantage that patterning of the exposure beam goes with less radiation loss. A digital mirror device comprises an array of individually controllable tiltable micro mirrors, which reflect incident radiation through the aperture of a projection lens or not and in this way represent a bright or dark pixel of an image. A DMD is currently as alternative for a LCD in an image projection device. Compared with a LCD, a DMD shows the advantage that it can be switched much faster. A deformable mirror device, or adaptive optical element is a mirror which surface can be deformed locally so that the direction of light reflected by the mirror can be locally controlled.

Preferably the device is further characterized in that an optical projection system is arranged between the spatial light modulator and the mould holder.

The projection system forms a sharp image of the pixel structure of the spatial light modulator in its focus plane. Usually the projection system is a lens system comprising one or more lenses. Alternatively the projection system may be a mirror system comprising one or more image forming mirrors. A mirror projection system will be employed if the exposure radiation has a wavelength for which no acceptable lens material is available.

Alternatively the device may be characterized in that the mould holder and the spatial light modulator are arranged close to each other without intervening optical means between them.

In this embodiment no projection system is used and the image of the pixel structure of the spatial light modulator is formed by so-called proximity imaging.

In contrast to a conventional photomask (which is digital) a spatial light modulator can generate UV light images containing a large number of different gray tones. Images can be made with gradually varying intensity which is desired to obtain the required surface relief pattern for a customized mould.

A preferred embodiment of the device is further characterized in that a diffuser element is arranged in the path of the exposure beam between the spatial light modulator and the mould holder.

Such a diffuser element will be used if the image of the SLM picture structure is imaged too sharp in the photoresist layer, i.e. the individual pixels of the SLM picture are “visible” in this layer. If a diffuser element is arranged in the path of the exposure beam, the exposure radiation will be scattered to a predetermined degree so that the image formed in the photoresist layer will become less sharp and the surface of the developed layer will become more smooth. The diffuser element may be constituted by a weak lens element, which is moved, fast or slow, for example in a circular translating movement. The diffuser element may also be a rotating flat glass plate which is slightly tilted with respect to axis of the exposure beam.

An alternative embodiment is characterized in that the mould holder is arranged at such distance from the projection system that the photoresist layer on the mould to be exposed is outside the focus plane of the projection system.

This arrangement also ensures that the image of the SLM picture formed in the photoresist layer is not to sharp and thus that the surface of the developed layer is sufficiently smooth.

The device is preferably further characterized in that the spatial light modulator is coupled to a computer, which supplies data about the exposure pattern to be formed in the photoresist layer.

In case a mould for a contact lens has to be manufactured, data about the required eye correction are processed by the computer to parameter values for the spatial light modulator and the computer controls the whole exposure process.

These and other aspects of the invention are apparent from and will be elucidated, by way of non-limitative example, with reference to an embodiment of the method for manufacturing a mould for producing a contact lens described hereinafter. In the drawings:

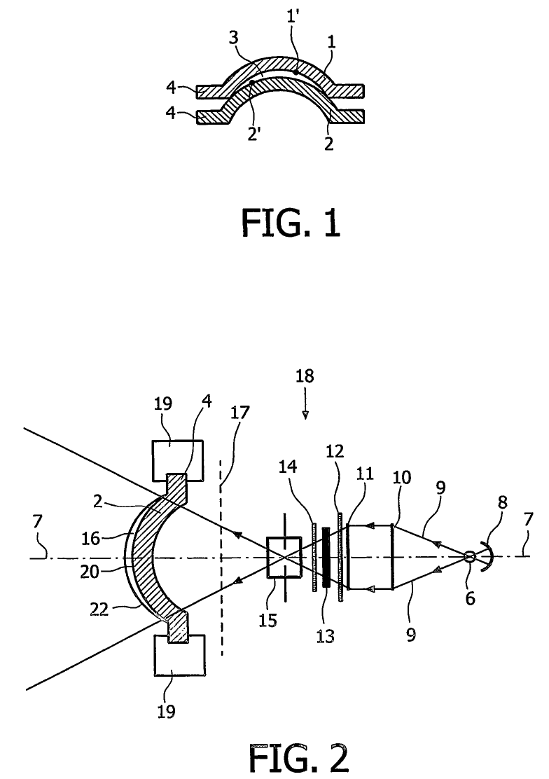

FIG. 1 shows a sectional view of a mould for producing a contact lens, and

FIG. 2 shows an embodiment of a device for shaping a mould.

The figures are only schematical representations and show only those components, which are relevant for understanding the invention.

FIG. 1 shows a composed mould for producing a contact lens. The composed mould comprises two moulds, a mould 1 having concave mould surface 1′, which is used for shaping the convex front surface of the contact lens, and a mould 2 having a convex mould surface 2′, which is used for shaping the concave back surface of the contact lens. The back surface abuts the eye when the contact lens is placed on the eye and is also called base side of the contact lens. Both moulds 1,2 are provided with a circular edge portion 4, by which the part 1,2 can be clamped to keep it in a predetermined position during the production of a contact lens. Moulds 1 and 2 may both be made of a transparent plastic material and are manufactured, for example by a moulding operation by means of a metal mould. The concave surface of mould 1 and the convex surface of mould 2 must be smooth, so that the surfaces of the contact lens produced by means of these moulds do not need an additional finishing operation after the mould process.

To produce a contact lens, a UV hardening polymer is brought in the space 3 between the two transparent plastic moulds 1,2. Subsequently the composed mould with the polymer is subjected to UV light radiation so that the polymer is cured, or hardened. The result is a contact lens having a convex lens surface which shape is defined by the mould surface I′ and a concave lens surface, which shape is defined by the mould surface 2′. This generally known method for producing a contact lens is relative simple and can be performed at low costs.

FIG. 2 schematically shows an embodiment of a device for shaping a mould, like mould 1 or 2, by means of photolithography techniques. The device comprises a radiation source 6, for example a lamp 6, which emits ultraviolet (UV) radiation. The source is arranged at the optical axis 7 of the device and is, for example a 500 Watt mercury arc lamp. A reflector 8 arranged at the back side of the lamp reflects the backwards emitted radiation in the device so that the radiation emitted by the lamp is efficiently used. The exposure radiation is denoted by the rays 9. Two condenser lenses 10, 11 concentrate this radiation in a convergent exposure beam. This beam passes a spatial light modulator 18, which acts as a programmable photo mask, the mask pattern of which can be changed at will under control of a computer (not shown).

In the embodiment of FIG. 2 the spatial light modulator is a liquid crystal display (LCD), which comprises a polarizer 12, a liquid crystal panel 13 and an analyzer 14. The panel 13 comprises a two-dimensional array of a large number of cells, or pixel elements (pixels), which can be controlled individually by means of an electronic circuit integrated in the panel. Depending on the type of panel, it cells rotate, in the on- or off-state, the polarization direction of the incident radiation, which has been polarized in a predetermined direction by the polarizer 12, so that the radiation from such a cell can not pass the analyzer 14, which has the same polarization direction as the polarizer. Such a cell represent a black pixel and a cell which does not rotate the polarization direction represents a white pixel. In this way the LCD can generate a pattern of white and black areas. Upon passage through the LCD, the exposure beam is modulated with this pattern. This LCD panel can display not only a black and white pattern, but also a pattern with gray tones, i.e. intensities in the range from high to zero.

Instead of a transmission LCD used in the embodiment of FIG. 2, also a reflective LCD may be used. A reflective LCD has the advantage that it shows less radiation loss so that in a device wherein a reflective LCD is used the available radiation is used more efficiently.

The spatial light modulator 18 may also be constituted by a digital mirror device (DMD). Such a device comprises a two-dimensional array of a large number of micro mirrors, which can be controlled individually. These mirrors can be tilted under control of an electronic circuit integrated in the device. Depending on the type of device a tilted mirror, in its on- or off-state, reflects incident radiation such that it does not enter a further optical element of the mould shaping device. Such a tilted mirror represents a black pixel and a mirror which is in its zero position represents a white pixel. The micro mirrors can be tilted at different angles so that the pixels can be given different gray tones. In this way a DMD device, which is currently used for image display can be used to generate a pattern of areas having a varying brightness, from high to zero.

Another type of spatial light modulator that can be used in the shaping device of the present invention is a deformable mirror or adaptive optical element. The shape of such an element can be locally deformed under control of an electronic circuit which supplies control signals to means which forces areas of the mirror or element to deform. A local deformation changes the direction or the phase of incident radiation, which results in the formation of an intensity pattern in the beam coming from the deformable mirror or the adaptive element.

Also other types of spatial light modulators may be used. Essential is that the spatial light modulators generate an intensity pattern that varies over a broad range so that a broad range of intensities can be projected on the mould to be processed.

It will be clear that if a reflective SLM (a reflective LCD, a DMD or a deformable mirror) the radiation source 7 and the beam shaping means 10 and 11 have to be placed at the left side of the SLM 18, instead of at its right side, as shown in FIG. 2 for a transmission SLM.

This mould is denoted by reference number 2 in FIG. 2. It is fixed through its circular edge portion 4 in a mould holder 19. To change the original convex mould shape 20 of the mould it is coated with a photoresist layer 16, which is sensitive for the exposure radiation used in the device of FIG. 2, in this case UV radiation. The photoresist is, for example an UV sensitive polymer. After the photoresist layer has been coated on the mould, for example by means of spin-coating, it is baked during a predetermined time and at a predetermined temperature, whereby the solvent is removed. The mould with the photoresist layer is than placed in the mould holder and exposed to the exposure beam 9 which has been patterned by the spatial light modulator according to the above-mentioned ophthalmic data. After exposure the photoresist layer is developed, whereby, depending on the type of photoresist the exposed portion or non-exposed portion portions are removed to a depth depending on the intensity of the local exposure. In this way, a to-dimensional SLM pattern is transferred to a three-dimensional pattern in the photoresist layer and the required mould surface is printed in the external surface of 22 of the photoresist layer 16.

In the embodiment shown in FIG. 2, the photoresist layer is exposed through the mould 2 material,. which requires a transparent mould material. This material is for example a transparent plastic. Exposure through the mould is preferred if the photoresist is a negative photoresist to obtain a smooth resist profile with gradually varying thickness of the layer 16. For the same reason a positive photoresist layer on top of the mould is preferably exposed from the front side.

In case still a better smoothness of the mould surface 22 is required, the photoresist layer 16 may undergo a surface finish baking step, whereby the mould 2 and layer 16 is heated to a predetermined temperature during a predetermined time, which step results in the surface 22 to become more smooth.

Preferably, and as shown in FIG. 2, a projection system 15 is arranged between the SLM 18 and the mould with photoresist layer, to image the SLM pattern in the photoresist layer. The projection system usually will be a lens system comprising one or more lens(es), but may also be a mirror projection system comprising one or more mirrors. A mirror projection system will be used if it is preferred to use exposure radiation having a wavelength (deep UV) for which no acceptable lens material is available.

It is also possible to transfer the SLM pattern in the photoresist layer by means of the proximity printing technique. The front side 22 is then arranged close to the SLM without a projection system (intervening optical means) arranged between them. The radiation from the SLM is directly incident on the front surface via a small air gap between this surface and the SLM. For such an arrangement a positive photoresist will be preferred.

As the SLM pattern has a pixel structure and the projection system forms a sharp image of this pattern in the photoresist layer if this layer is arranged in the focal plane of the projection system, the printed pattern may also show a pixel, i.e. non-smooth structure. This can be avoided by arranging the photoresist layer outside the focal plane of the projection system. The image of the SLM pattern will be smeared then to a sufficient extent so that the printed mould surface will show smooth transitions between the diferent surface levels.

Another way to prevent formation of a pixilated mould surface is to arrange a diffuser between the projection system and the photoresist layer. Such a diffuser scatters the radiation of the exposure beam to a predetermined degree, which results in smearing the image of the SLM pattern. This diffuser is preferably a dynamic diffuser, i.e. a diffuser showing a time varying spatial scattering. Such a diffuser may be formed by a weak lens element, which is moved, fast or slow, for example in a circular translation movement. The diffuser may also be a rotating glass plate which is slightly tilted with respect to the axis of the exposure beam.

The final material thickness distribution of the remaining photoresist layer after development and post-baking depends on a number of parameters, such as the pattern generated by the SLM, the total exposure time, the intensity of the exposure beam from the source and the properties of the photoresist material, such as its speed and contrast.

In case a customized composed mould for producing a contact lens has to be manufactured, two moulds are produced in the way described above, whereby the required gray tone pattern generated by the SLM is derived from ophthalmic measurement data, which are supplied to the device via a computer.

If a mould with a complicated three-dimensional structure has to be manufactured the above described mould manufacturing process may be repeated one or more times, dependent on the complexity of the required surface profile.

That the invention has been described at the hand of the manufacture of a mould for a contact lens, does not mean that the invention is limited to this application. The invention may also be used for manufacturing moulds for spectacle glasses, which glasses can be produced by glass-pressing or plastic mould techniques. The invention can also be used for producing correcting phase plates, which can be used in optical instruments or apparatuses for correcting residual optical aberrations in such instruments or apparatuses. Such a correction plate may can be produced in the same way as a contact lens, i.e. via a mould, but also directly and in the same way as such mould, because the used technique is simple and cheap. The invention can be used in general for producing an optical surface is small quantities, from one to a few.

1. A method of manufacturing a mould for producing a customized optical surface, whereby a mould having a base shape is modified to obtain the required shape of the mould surface, characterized in that use is made of a photolithographic process, comprising the steps of
providing the mould surface with photoresist layer;
exposing the photoresist layer to a predetermined pattern of exposure radiation during a predetermined time, and
developing the photoresist layer, thereby selectively removing photoresist material according to the radiation pattern and shaping the exposed surface of the layer to the required end shape of the mould,

2. A method as claimed in claim 1, characterized in that use is made of a negative-photoresist layer.

3. A method as claimed in claim 1, characterized in that the mould is made of a material that is transparent to the exposure radiation.

4. A method as claimed in claim 1, characterized in that the mould is made of a plastic material.

5. A method as claimed in claim 2, characterized in that the photoresist layer is exposed via the mould.

6. A method of manufacturing a composed mould for producing a contact lens, which composed mould comprises a first and a second mould for forming a first surface and a second surface, respectively of the contact lens, characterized in that each of the moulds is manufactured by the method as claimed in claim 1.

7. A method of manufacturing a contact lens comprising a first, concave, surface and a second, convex, surface, which method comprises the steps of:
providing a composed mould comprising a first mould having a surface, which is the negative of the first lens surface, and a second mould having a surface, which is the negative of the second lens surface;
filling the space between the mould surface with a polymer material;
exposing the polymer material to UV radiation thereby hardening the material and shaping it to a lens having the said first and second surface, characterized in that use is made of a composed mould manufactured according to the method of claim 6.

8. A contact lens manufactured by means of the method claim 7.

9. A device for performing the exposure step of the method of claim 1, characterized in that it comprises in this order:
a radiation source emitting UV radiation;
optical means for concentrating the emitted radiation in an exposure beam;
a spatial light modulator for imparting to the exposure beam a radiation distribution according to the said predetermined pattern, and
a mould holder arranged in the path of the radiation from the spatial light modulator for holding the mould to be exposed.

10. A device as claimed in claim 9, characterized in that the spatial light modulator is one of the types: liquid crystal display (LCD), digital mirror device and deformable mirror device.

11. A device as claimed in claim 9, characterized in that an optical projection system is arranged between the spatial light modulator and the mould holder.

12. A device as claimed in claim 9, characterized that the mould holder and the spatial light modulator are arranged close to each other without intervening optical means between them.

13. A device as claimed in claim 9, characterized in that a diffuser element is arranged in the path of the exposure beam between the spatial light modulator and the mould holder.

14. A device as claimed in claim 9, characterized in that the mould holder is arranged at such distance from the projection system that the photoresist layer on the mould to be exposed is outside the focus plane of the projection system.

15. A device as claimed in claim 9, characterized in that the spatial light modulator is coupled to a computer, which supplies data about the exposure pattern to be formed in the photoresist layer.
